(19) United States
(12) Patent Application Publication
(10) Pub. No.: US 2021/0397050 A1
(43) Pub. Date: Dec. 23, 2021

(54) BACKLIGHT DEVICE AND DISPLAY DEVICE

(71) Applicant: SHARP KABUSHIKI KAISHA, Sakai City, Osaka (JP)

(72) Inventor: ATSUYUKI TANAKA, Sakai City, Osaka (JP)

(21) Appl. No.: 17/289,211

(22) PCT Filed: Oct. 9, 2019
(86) PCT No.: PCT/JP2019/039760

§ 371 Date: Apr. 27, 2021

(30) Foreign Application Priority Data
Nov. 1, 2018 (JP) 2018-206368

(51) Int. Cl. G02F 1/1335; G02F 1/13357

(52) U.S. Cl. CPC G02F 1/133614; G02F 1/133605; G02F 1/133603

(57) ABSTRACT

A backlight device including a combination of light-emitting elements and a wavelength conversion substance is provided at low cost. The backlight device includes: a plurality of light-emitting bodies arranged in a planar manner, the light-emitting bodies being configured to emit first light upwards; and a transparent plate above the light-emitting bodies. The plate includes a plurality of wavelength conversion sections arranged next to each other in a lateral direction, the wavelength conversion sections being configured to convert the first light to second light. Each of the wavelength conversion sections at least partially overlaps at least one of the light-emitting bodies when viewed from above.

### TECHNICAL FIELD

The following disclosure relates to backlight devices and display devices. The present application claims the benefit of priority to Japanese Patent Application, Tokugan, No. 2018-206368 filed Nov. 1, 2018, the entire contents of which are incorporated herein by reference.

### BACKGROUND ART

White-shining area light source units are known that include blue light-emitting elements and a fluorescent sheet that emits yellow or orange light when hit by the light emitted by the light-emitting elements (see, for example, Patent Literature 1).

Liquid crystal display devices that perform area active drive are also known (see, for example, Patent Literature 2). In area active drive, the screen of a liquid crystal display device is divided into areas, and the luminance of the backlight light source is controlled for each area on the basis of the input image for that area. Area active drive is sometimes referred to as local dimming drive.

### CITATION LIST

### Patent Literature

Patent Literature 1: Japanese Unexamined Patent Application Publication, Tokukai, No. 2017-33927

Patent Literature 2: PCT International Application Publication No. WO2011/013402

### SUMMARY OF INVENTION

### Technical Problem

The conventional area light source unit includes a fluorescent sheet that has the same area as the light-emitting face thereof and for this reason requires a large amount of fluorescent material, which adds to the manufacturing cost of the area light source unit. The following disclosure has an object to provide low cost manufacturing technology for backlight devices.

### Solution to Problem

To address the problems described above, the present disclosure, in an aspect thereof, is directed to a backlight device including: a plurality of light-emitting bodies arranged in a planar manner, the light-emitting bodies being configured to emit first light upwards; and a transparent plate above the light-emitting bodies, wherein the plate includes a plurality of wavelength conversion sections arranged next to each other in a lateral direction, the wavelength conversion sections being configured to convert the first light to second light, and each of the wavelength conversion sections at least partially overlaps at least one of the light-emitting bodies when viewed from above.

### Advantageous Effects of Invention

The present disclosure, in an aspect thereof, can provide a backlight device that can be manufactured at low cost.

### BRIEF DESCRIPTION OF DRAWINGS

FIG. 1 is a block diagram of a configuration of a display device in accordance with a first embodiment.

FIG. 2 is a perspective view of the display device in accordance with the first embodiment.

FIG. 3 is a side view of a backlight device in accordance with the first embodiment.

FIG. 4 is a transparent view of a plate, wavelength conversion sections, and light-emitting bodies in accordance with the first embodiment as they are viewed from above.

FIG. 5 is a partial, vertical cross-sectional view of the backlight device taken along line V-V shown in FIG. 4.

FIG. 6 is an illustration of light propagating in a backlight device including a fluorescent sheet in accordance with a comparative example.

FIG. 7 is a side view of a backlight device in accordance with a second embodiment.

FIG. 8 is an illustration of a plate in accordance with the second embodiment as viewed from below.

FIG. 9 is a side view of a backlight device in accordance with a third embodiment.

FIG. 10 is an illustration of plates in accordance with the third embodiment as viewed from above.

FIG. 11 is a side view of a backlight device in accordance with a fourth embodiment.

FIG. 12 is an illustration of a plate in accordance with the fourth embodiment as viewed from above.

FIG. 13 is an illustration of the plate in accordance with the fourth embodiment as viewed from below.

FIG. 14 is a side view of a backlight device in accordance with a fifth embodiment.

FIG. 15 is a transparent view of a plate, wavelength conversion sections, and light-emitting bodies in accordance with the fifth embodiment as they are viewed from above.

FIG. 16 is a side view of a backlight device in accordance with a sixth embodiment.

FIG. 17 is a transparent view of a plate, wavelength conversion sections, and light-emitting bodies in accordance with the sixth embodiment as they are viewed from above.

### DESCRIPTION OF EMBODIMENTS

The following will describe embodiments with reference to attached drawings.

### 1. First Embodiment

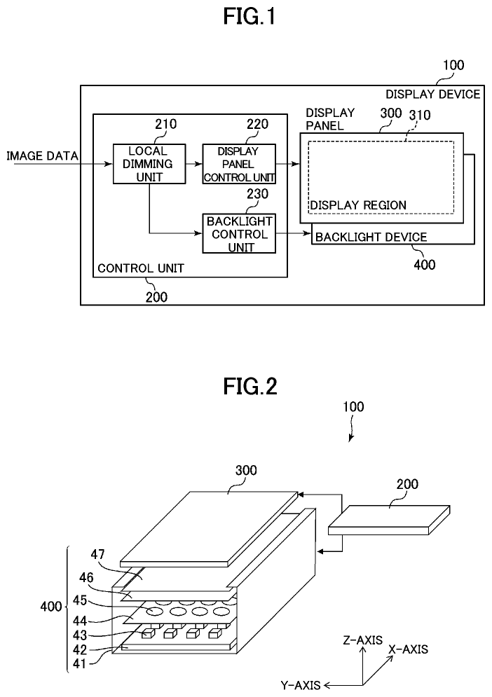

FIG. 1 is a block diagram of a configuration of a display device 100 in accordance with a first embodiment. The display device 100 includes a control unit 200, a display panel 300, and a backlight device 400. The display panel 300 has a display region 310 where images are displayed.

The control unit 200 feeds image data from the outside of the display device 100. The display device 100 may be fed with image data in any specific manner, for example, via an HDMI® cable or by television broadcasting waves from an external video output device. The control unit 200 controls the backlight device 400 and the display panel 300 based on image data sets each specific to one of the areas into which the display region 310 of the display panel 300 is divided, to implement local dimming drive in order to produce a display on the display region 310 based on the image data.

The display panel 300 produces a display based on the image data by using the light emitted from the backlight device 400. The display panel 300 in accordance with the first embodiment is a liquid crystal display panel. The display panel 300 includes a plurality of pixels. Each pixel is individually controlled to alter the transmittance thereof.

The backlight device 400 includes a plurality of light-emitting bodies to emit light in the direction of the display panel 300. The backlight device 400 will be described later in more detail.

A description is given next of a configuration of the control unit 200 in accordance with the first embodiment. The control unit 200 in accordance with the first embodiment includes a local dimming unit 210, a display panel control unit 220, and a backlight control unit 230. The local dimming unit 210 generates display panel control data and backlight device control data for implementing local dimming drive based on the incoming mage data. The local dimming unit 210 then sends the display panel control data to the display panel control unit 220 and sends the backlight device control data to the backlight control unit 230.

The display panel control unit 220 generates a control signal for controlling the transmittance of each pixel in the display panel 300 based on the display panel control data supplied from the local dimming unit 210, to drive the display panel 300. The backlight control unit 230 generates a control signal for controlling the light emission intensity of each light-emitting body in the backlight device 400 based on the backlight device control data supplied from the local dimming unit 210, to drive the backlight device 400.

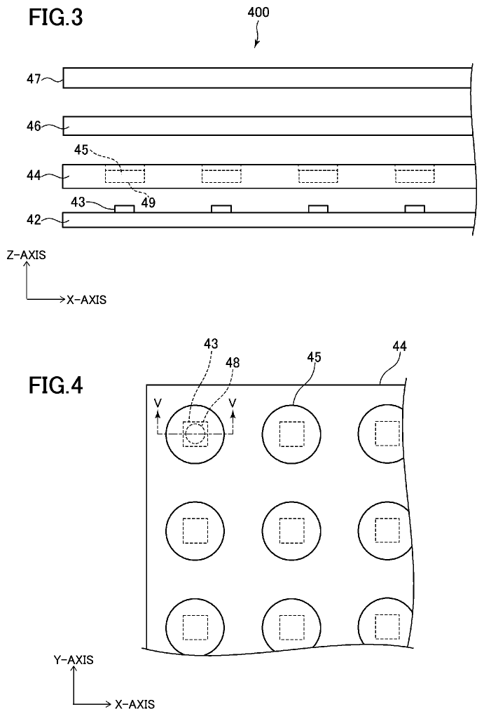

FIG. 2 is a perspective view of the display device 100 in accordance with the first embodiment. FIG. 3 is a side view of the backlight device 400 in accordance with the first embodiment. The display panel 300 is provided above the backlight device 400 as shown in FIG. 2 or 3. The positive direction on the Z-axis shown in FIGS. 2 and 3 is taken as the upward direction. The backlight device 400 includes a housing 41, a substrate 42, a plurality of light-emitting bodies 43, a plate 44, a plurality of wavelength conversion sections 45, a diffusion plate 46, and optical sheets 47. The plate 44 has a plurality of dents 49.

The housing 41 supports, for example, the substrate 42. The substrate 42 is made for example, metal and carries thereon the light-emitting bodies 43. A reflective sheet may be attached to the surface of the substrate 42 to enhance the use efficiency of the light emitted from the light-emitting bodies 43. In FIG. 3, the wavelength conversion sections 45 and the dents 49 are invisible and therefore indicated by dotted lines.

The light-emitting bodies 43 emit light upwards and are arranged in a planar manner on the substrate 42. The light-emitting body 43 is a chip LED fabricated by, for example, sealing an LED element with a resin or like material and attaching wires to the sealed LED element for external contacts. Each light-emitting body 43 may include a single LED element or a plurality of LED elements. In the first embodiment, the light-emitting body 43 is a blue chip LED and emits blue light.

The plate 44 is a transparent platelike member and provided above the light-emitting bodies 43. The dents 49 are provided at prescribed intervals in the top face of the plate 44. Each dent 49 contains therein a different one of the wavelength conversion sections 45. The light-emitting bodies 43 are separated by a gap from the plate 44. In other words, the light-emitting bodies 43 are separated by a gap from the wavelength conversion sections 45 in the plate 44. This particular structure can slow down the degradation of the wavelength conversion sections 45 under the heat discharged by the light-emitting bodies 43.

The wavelength conversion section 45 absorbs and converts part of the light emitted by the light-emitting body 43 to light of a wavelength that is different from the wavelength of the absorbed light before emitting the resultant light. The reset of the light from the light-emitting body 43 passes through the wavelength conversion section 45 without being absorbed by the wavelength conversion section 45. Hence, both the non-absorbed light and the absorbed and wavelength-converted light comes out of the wavelength conversion section 45. The wavelength conversion section 45 contains a wavelength conversion material and is encased in, for example, a resin. In the first embodiment, the wavelength conversion section 45 contains quantum dots as the wavelength conversion material. More specifically, the wavelength conversion section 45 contains quantum dots for converting blue light to green light and quantum dots for converting blue light to red light. Because green light and red light mix to produce yellow light, the wavelength conversion section 45 converts first light (blue light) emitted by the light-emitting body 43 to second light (yellow light). The wavelength conversion section 45 alternatively converts the first light (blue light) emitted by the light-emitting body 43 to second light (either of green and red light) and third light (the other of green and red light). The part of the first light emitted by the light-emitting body 43 that is passed through the wavelength conversion section. 45, the part of the first light emitted by the light-emitting body 43 that is passed not through the wavelength conversion section 45, and the second light emitted by the wavelength conversion section 45 mix to produce white light. The light obtained by the conversion by the quantum dots exhibits so small a full width at half maximum that the light is highly pure. The inclusion of quantum dots in the wavelength conversion section 45 can therefore expand the color reproduction range of the display device 100.

The wavelength conversion sections 45 in accordance with the first embodiment are arranged next to each other in a lateral direction in the plate 44. The “lateral direction” is perpendicular to the thickness direction of the plate 44 and matches either the X-axis or Y-axis direction shown in FIGS. 2 and 3. This particular structure requires less wavelength conversion material to manufacture the backlight device 400 in accordance with the first embodiment than to manufacture the conventional area light source unit including a fluorescent sheet that has the same area as the light-emitting face thereof, which in turn leads to decreases in the manufacturing cost of the backlight device 400. In addition, because the wavelength conversion sections 45 and the plate 44 in accordance with the first embodiment are integrated, the wavelength conversion sections 45 can be positioned above the respective light-emitting bodies 43, which facilitates the assembly of the backlight device 400.

The plate 44 is made of a transparent white material in the first embodiment. The plate 44 hence scatters incident light. This property enables the plate 44 to well mix the light coming from the light-emitting body 43 and the light coming from the wavelength conversion section 45, which in turn better restrains irregular color mixing in white light.

The diffusion plate 46 is provided above the plate 44. The diffusion plate 46 diffuses the light emitted by the light-emitting bodies 43 and the wavelength conversion sections 45 so that the backlight emission can be uniform across the plane.

The optical sheets 47 are provided above the diffusion plate 46. Each optical sheet 47 is responsible for a different function such as diffusion, converging, or light use efficiency enhancement.

FIG. 4 is a transparent view of the plate 44, the wavelength conversion sections 45, and the light-emitting bodies 43 in accordance with the first embodiment as they are viewed from above. Referring to FIG. 4, the light-emitting body 43 includes a light-exiting portion 48 on the top face thereof. The light-exiting portion 48 provides an exit for the light produced inside the light-emitting body 43. The light-exiting portion 48 is circular in the example shown in FIG. 4, but may have another shape.

The wavelength conversion section 45 needs only to be at least partially overlapping the light-emitting body 43 when viewed from above. In the first embodiment, the wavelength conversion section 45 is positioned overlapping the entire light-emitting body 43 when viewed from above as shown in FIG. 4. In other words, the wavelength conversion section 45 is provided in the passage of the light exiting the light-emitting body 43. The wavelength conversion section 45 can hence efficiently convert the light emitted by the light-emitting body 43.

The wavelength conversion section 45 in accordance with the first embodiment is circular as shown in FIG. 4 when viewed from above. Light exits upwards through the light-exiting portion 48 with a generally spherical light distribution. The wavelength conversion section 45, which receives this light, is therefore also circular, so that the wavelength conversion section 45 can receive the light more uniformly in the circumference direction for more uniform wavelength conversion. This particular structure hence reduces irregular color mixing.

The wavelength conversion section 45 in accordance with the first embodiment has a larger diameter than the dimensions of the light-exiting portion 48 as shown in FIG. 4. Light exits upwards through the light-exiting portion 48 with a generally spherical light distribution as described above. In other words, the light exiting through the light-exiting portion 48 spreads in various directions. Hence, by having a larger diameter than the dimensions of the light-exiting portion 48, the wavelength conversion section 45 can absorb much light for wavelength conversion. Accordingly the wavelength conversion section 45 can more efficiently wavelength-convert the light exiting through the light-exiting portion 48.

FIG. 5 is a partial, vertical cross-sectional view of the backlight device taken along line V-V shown in FIG. 4. The plate 44 in accordance with the first embodiment shown in FIG. 5 has the dents 49 in the top face thereof. The wavelength conversion sections 45 in accordance with the first embodiment sit in the dents 49. The dents 49 may alternatively be provided in the bottom face of the plate 44. In other words, the plate 44 has the dents in either one or both of the top and bottom faces thereof.

The plate 44 is formed, for example, by injection molding in a metal die that has convexities for the dents 49. This particular technique can readily provide the plate 44 with the dents 49 of prescribed dimensions in prescribed locations. The wavelength conversion sections 45 may be formed, for example, by pouring a photocuring or thermosetting resin containing quantum dots into the dents 49 and curing the resin under light or heat. Alternatively, the wavelength conversion sections 45 may be formed, for example, by preparing disc-shaped resin pellets encasing quantum dots in advance and placing the pellets in the dents 49. The use of the plate 44 having the dents 49 fabricated in this manner allows for the provision of the wavelength conversion sections 45 in the dents 49. The wavelength conversion sections 45 are thus readily provided in prescribed locations.

Since the dents 49 reside in the top face of the plate 44, and the wavelength conversion sections 45 sit in the dents 49 as described above, the plate 44 is sandwiched between the wavelength conversion sections 45 and the light-emitting bodies 43. The wavelength conversion sections 45 are therefore not directly exposed to heat discharged by the light-emitting bodies 43. That in turn restrains the wavelength conversion sections 45 from being degraded by the heat discharged by the light-emitting bodies 43.

The top face of the wavelength conversion section 45 resides below the top face of the plate 44 as shown in FIG. 5. This particular structure permits better mixture of the light emitted by the light-emitting bodies 43 and the light obtained by the conversion by the wavelength conversion section 45, thereby producing more uniform white light, presumably for the following reasons. The light obtained by the wavelength-conversion by the wavelength conversion section 45 (hereinafter, will be referred to as the “conversion light”) comes out in greater amounts along the periphery of the wavelength conversion section 45 than in the center thereof because the light converted in the center of the wavelength conversion section 45 partially propagates through the inside of the wavelength conversion section 45 and exits the wavelength conversion section 45 through the periphery thereof. If this part of the conversion light was allowed to exit the wavelength conversion section 45 under these conditions, the positional difference in the amount of outgoing conversion light could lead to irregular color mixing. This potential problem is addressed by positioning the top face of the wavelength conversion section 45 below the top face of the plate 44 as shown in FIG. 5. The side face of the dent 49 serves as a wall in this layout when the wavelength conversion section 45 is viewed from above. The conversion light exiting the wavelength conversion section 45 through the top face thereof in the direction of the wall cannot propagate in a straight line and reflects or refracts at the wall. This mechanism can average out the positional difference in the amount of outgoing conversion light and hence reduce irregular color mixing.

The light-emitting body 43 in accordance with the first embodiment has 2.5 mm×2.5 mm dimensions when viewed from above. The light-emitting body 43 has a height of 0.58 mm. The plate 44 is made of a transparent white polycarbonate resin. The plate 44 has a thickness of 2.0 mm. The plate 44 exhibits a total optical transmittance of 45.0% in portions where there exist no wavelength conversion sections 45. The top faces of the light-emitting bodies 43 and the bottom face of the plate 44 are separated by a distance of 1.42 mm. In other words, the light-emitting bodies 43 and the plate 44 are separated by a gap of 1.42 mm. The bottom faces of the light-emitting bodies 43 and the bottom face of the plate 44 are separated by a distance of 2.0 mm. The dents 49 are depressed by 1.5 mm from the top face of the plate 44. The bottom faces of the dents 49 and the bottom face of the plate 44 are therefore separated by a distance of 0.5 mm. The wavelength conversion sections 45 each have a diameter of 6.0 mm and a thickness of 1.0 mm. The top faces of the wavelength conversion sections 45 therefore reside 0.5 mm below the top face of the plate 44. This set of dimensions, as an example, can further reduce irregular color mixing.

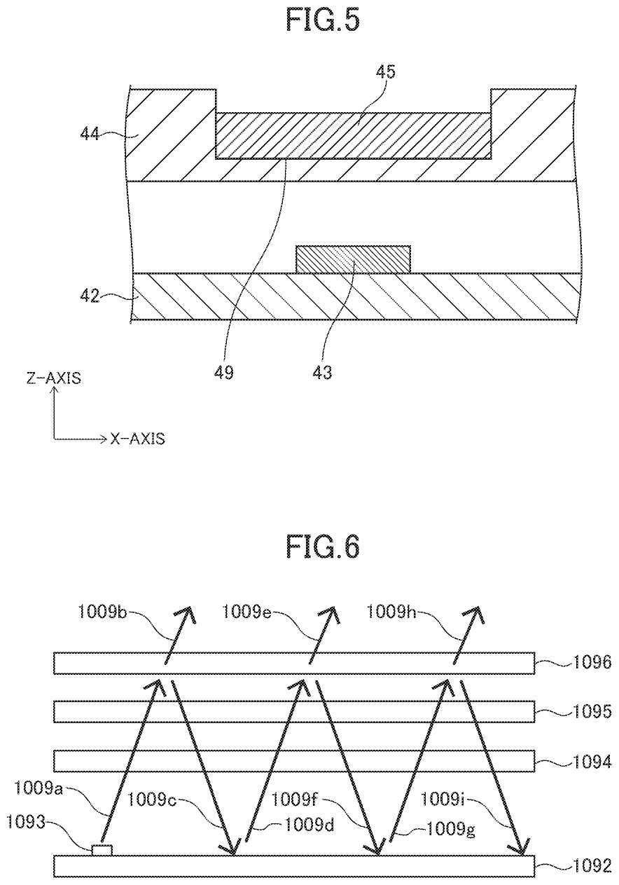

When a display device including a display panel and a backlight device is subjected to local dimming drive as described above, the backlight device lights up partially where some light-emitting bodies emit light while the others do not emit light (“partial lighting”). If the backlight device includes a fluorescent sheet that has the same area as the entire light-emitting face of the backlight device as described in, for example, Patent Literature 1, irregular color mixing can occur. This phenomenon is discussed with reference to FIG. 6 as a comparative example.

FIG. 6 is an illustration of light propagating in a backlight device including a fluorescent sheet in accordance with a comparative example. Light 1009a emitted from a blue LED 1093 passes through a fluorescent sheet 1095 and splits into light 1009b that passes through an optical sheet 1096 and light 1009c that reflects from the optical sheet 1096. In other words, the light 1009a emitted from the blue LED 1093 partially reflects from the optical sheet 1096 and returns toward an LED substrate 1092. Because the LED substrate 1092 typically has a reflective sheet attached to the surface thereof to reflect light, the light 1009c having reflected from the optical sheet 1096 further reflects from the LED substrate 1092 as reflection 109d. The reflection 109d passes through the fluorescent sheet 1095 and then splits into light 1009e that passes through the optical sheet 1096 and light 1009f that reflects from the optical sheet 1096. Likewise, the light 1009f having reflected from the optical sheet 1096 reflects from the LED substrate 1092, and light 1009g having reflected from the LED substrate 1092 splits into light 1009h that passes through the optical sheet 1096 and light 1009i that reflects from the optical sheet 1096. As light is repeatedly reflected as described here, the light takes on an increasingly more yellow tint every time the light passes through the fluorescent sheet 1095. Therefore, the emission of each blue LED 1093 becomes increasingly more yellowish as the emission moves away from the blue LED 93. In the example shown in 6, the light 1009e is more yellowish than the light 1009b, and the light 1009h is even more yellowish than the light 1009e. The emission of the blue LED 1093 thus reaches the surrounding regions by being repeatedly reflected while becoming increasingly more yellowish. Therefore, in partial lighting, the light becomes more yellowish as the light moves away from the source thereof. This phenomenon is the irregular color mixing described above. Due to the phenomenon, the backlight device shown in FIG. 6, when subjected to local dimming drive, suffers from irregular color mixing, hence from image quality degradation.

In contrast, in the backlight device 400 in accordance with the first embodiment, the wavelength conversion sections 45 at least partially overlap the respective light-emitting bodies 43 when viewed from above. In other words, a light-emitting body 43 and a wavelength conversion section 45 positioned over the light-emitting body 43 are paired up producing white light emission that is free from irregular color mixing. The display device 100 including the backlight device 400 in accordance with the first embodiment thus causes no irregular color mixing in local dimming drive, thereby preventing image quality degradation.

### 2. Second Embodiment

A description is given next of a backlight device 400A in accordance with a second embodiment. The description will focus on distinctions between the backlight device 400A and the first embodiment and may not mention similarities between the backlight device 400A and the first embodiment.

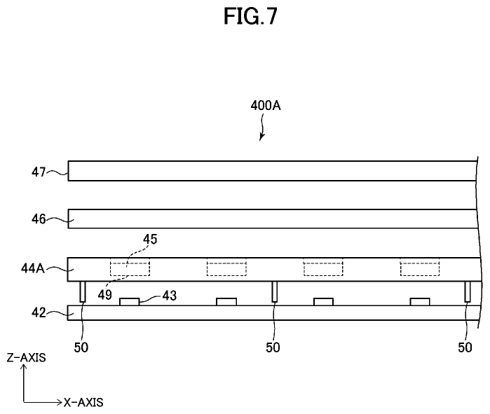

FIG. 7 is a side view of the backlight device 400A in accordance with the second embodiment, The members of the second embodiment that are the same as those of the first embodiment are denoted by the same reference numerals in FIG. 7, and description thereof is omitted. The backlight device 400A includes a plate 44A. The plate 44A includes a frame member 50 on the bottom face thereof, more specifically on the surface thereof that faces the light-emitting bodies 43. The frame member 50 divides the plate 44A into a plurality of regions. More specifically, the frame member 50 divides the space on the bottom thee of the plate 44A into a plurality of regions. The frame member 50 may be made of the same substance as the plate 44A.

The frame member 50 may be integrated to the plate 44A.

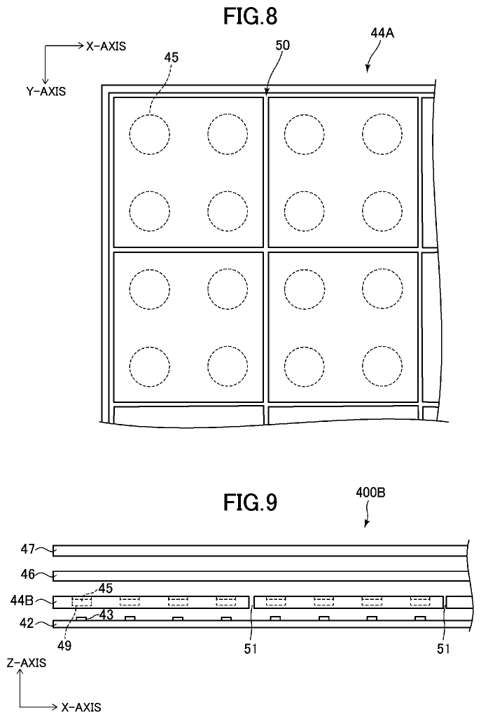

FIG. 8 is an illustration of the plate 44A in accordance with the second embodiment as viewed from below. The negative direction on the Z-axis shown in FIG. 7 is taken as the downward direction. The wavelength conversion sections 45 are provided behind the plate 44A and therefore shown with dotted lines. The regions created by the frame member 50 match the areas in local dimming drive described above. In the second embodiment, the frame member 50 is provided so as to enclose four (2×2) wavelength conversion sections 45 in each region. In other words, in the second embodiment, the frame member 50 is provided so as to enclose four light-emitting bodies 43 associated respectively with four (2×2) wavelength conversion sections 45 in each region. The frame member 50 may be altered in accordance with changes in the area settings for local dimming drive.

In each region enclosed by the frame member 50, the frame member 50 reflects the light emitted from the light-emitting bodies 43 in the region to prevent the light from leaking out of the region, thereby enhancing light use efficiency. When the light-emitting bodies 43 are turned on in some of the areas of the backlight device 400A in local dimming drive, the frame member 50 can enhance the use efficiency of the light emitted by the light-emitting bodies 43 inside those areas and also prevent, the light from leaking out of the areas, which can in turn improves the effects of the local dimming drive.

FIG. 7 shows the frame member 50 not in contact with the substrate 42 positioned therebelow. This particular structure allows for air flows between the frame member 50 and the substrate 42, which is advantageous in dissipating the heat discharged by the light-emitting bodies 43. Alternatively, the frame member 50 may be in contact with the substrate 42, in which case the frame member 50 helps fix the distance between the plate 44A and the substrate 42.

FIG. 8 shows the frame member 50 enclosing each region without leaving any gap around the region. Alternatively, as an example, the frame member 50 may not be provided on a part of the plate 44A, which allows for air flows along that part of the plate 44A. This is advantageous in dissipating the heat discharged by the light-emitting bodies 43.

### 3. Third Embodiment

A description is given next of a backlight device 400B in accordance with a third embodiment. The description will focus on distinctions between the backlight device 400B and the first embodiment and may not mention similarities between the backlight device 400B and the first embodiment.

FIG. 9 is a side view of the backlight device 400B in accordance with the third embodiment. The members of the third embodiment that are the same as those of the first embodiment are denoted by the same reference numerals in FIG. 9, and description thereof is omitted. The backlight device 400B includes a plurality of plates 44B arranged in a planar manner. Each plate 44B is separated by a clearance 51 from the adjacent plates 44B. There is also provided a separate member (not shown) that allows for the provision of the clearance 51 between the plates 44B.

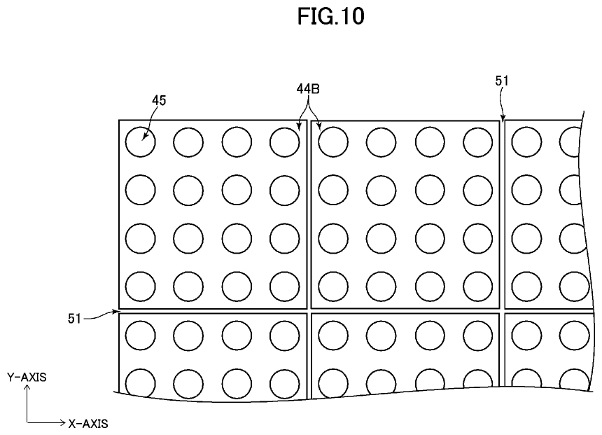

FIG. 10 is an illustration of the plates 44B in accordance with the third embodiment as viewed from above. The plates 44B are arranged in a planar manner as described above. The clearance 51 extends both in the X-axis direction and in the Y-axis direction between the plates 44B. FIG. 10 shows the clearance 51 having the same dimensions along the X-axis direction and along the Y-axis direction. Alternatively, the clearance 51 may have different dimensions along the X-axis direction and along the Y-axis direction. As another alternative, the clearance 51 may be provided only either along the X-axis direction or along the Y-axis direction. The clearance 51 is not essential.

FIG. 10 shows each plate 44B including sixteen (4×4) wavelength conversion sections 45. The number and shape are not necessarily limited to this example.

Taking a large-sized display device as an example, it becomes difficult to manufacture and assemble the backlight device if the plate has the same size as the display section. In contrast, since the plates 44B in accordance with the third embodiment are arranged in a planar manner as described above, the individual plates 44B are small and easy to manufacture. In addition, since the individual plates 44B are light and small, the individual plates 4413 are easy to handle, which makes it easy to assemble the backlight device 400B.

In the backlight device, the light-emitting bodies generate heat that in turn expands the plate. If the plate has the same size as the display section, the thermal expansion of the plate could cause large displacement of the wavelength conversion sections in the plate relative to the light-emitting bodies. However, since the plates 44B in accordance with the third embodiment are arranged in a planar manner, and the clearance 51 is provided between the adjacent plates 44B, the clearance 51 can prevent the displacement by making up for the effects of the expansion.

### 4. Fourth Embodiment

A description is given next of a backlight device 400C in accordance with a fourth embodiment. The description will focus on distinctions between the backlight device 400C and the first embodiment and may not mention similarities between the backlight device 400C and the first embodiment.

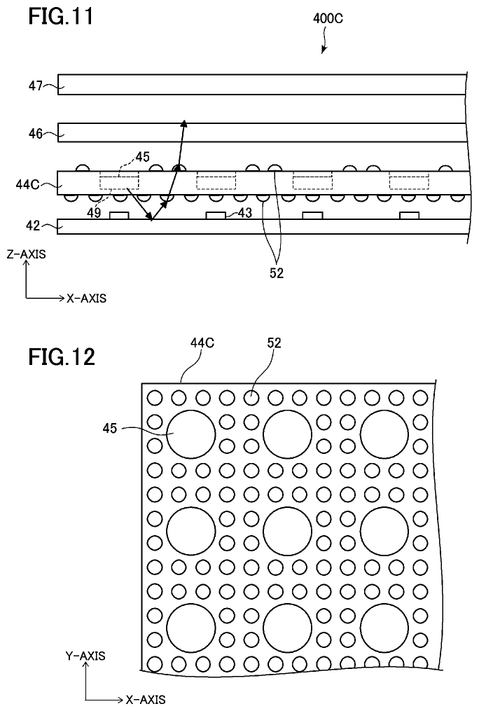

FIG. 11 is a side view of the backlight device 400C in accordance with the fourth embodiment. The members of the fourth embodiment that are the same as those of the first embodiment are denoted by the same reference numerals in FIG. 11, and description thereof is omitted. The backlight device 400C includes a plate 44C.

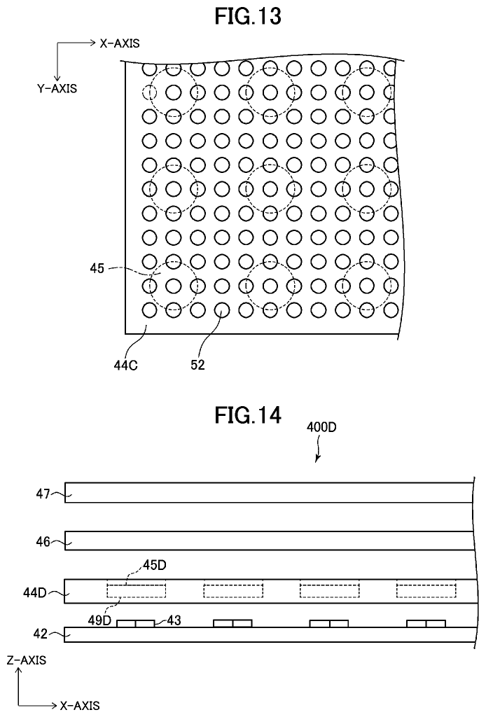

FIG. 12 is an illustration of the plate 44C in accordance with the fourth embodiment as viewed from above. FIG. 13 is an illustration of the plate 44C in accordance with the fourth embodiment as viewed from below. In FIG. 13, the wavelength conversion sections 45 are provided behind the plate 44C and therefore shown with dotted lines. Referring to FIGS. 11 to 13, the plate 44C includes a plurality of semi-spherical projections 52 on the top and bottom faces thereof. The projections 52 may be made integrally of the same substance as the plate 44C. The projections 52 on the top face of the plate 44C are offset from the projections 52 on the bottom face of the plate 44C when viewed from above. The layout of the projections 52 is not necessarily limited to this example.

There are provided no projections 52 above and below the wavelength conversion sections 45 in the fourth embodiment as shown in FIGS. 11 and 12 because the wavelength conversion sections 45 are formed or attached later to the plate as described above, and it is hence difficult to form the projections 52 above and below the wavelength conversion sections 45. If, for example, the projections 52 are attached later, it is possible to form the projections 52 above and below the wavelength conversion sections 45.

In the backlight device in accordance with the present disclosure, light is emitted downwards from the wavelength conversion sections 45, for example, as indicated by thick arrows in FIG. 11. In the absence of the projections 52, this light could be trapped inside the backlight device and not contribute at all to the light emission of the backlight device of the present disclosure. In the presence of the projections 52, however, the light can change direction toward the vertical as the light travels upwards as indicated by a thick arrow in FIG. 11, so that the light can leave the backlight device. The plate 44C in accordance with the fourth embodiment advantageously increases the amount of light leaving the backlight device 400C as described her owing to the provision of the projections 52, The optical sheets 47 shown in FIG. 3 include an optical sheet that enhances light use efficiency as described above. The plate 44C in accordance with the fourth embodiment functions similarly to this sheet. Therefore, the use of the plate 44C in accordance with the fourth embodiment allows for a reduction in the number of sheets used to enhance light use efficiency.

The shape and layout of the projections 52 shown in FIGS. 11 to 13 are mere examples. Alternatively, for example, the projections 52 may be shaped like a triangular-based pyramid or a rectangular-based pyramid. FIGS. 11 to 13 show the projections 52 being provided on both the top and bottom faces of the plate 44C. Alternatively, the projections 52 may be provided on at least either one of the top and bottom faces of the plate 44C.

### 5. Fifth Embodiment

A description is given next of a backlight device 400D in accordance with a fifth embodiment. The description will focus on distinctions between the backlight device 400D and the first embodiment and may not mention similarities between the backlight device 400D and the first embodiment.

FIG. 14 is a side view of the backlight device 400D in accordance with the fifth embodiment. The members of the fifth embodiment that are the same as those of the first embodiment are denoted by the same reference numerals in FIG. 14, and description thereof is omitted. The backlight device 400D includes a plate 44D and a plurality of wavelength conversion sections 45D. The plate 44D further has a plurality of dents 49D at prescribed intervals in the top face thereof. Each dent 49D contains therein a different one of the wavelength conversion sections 45D.

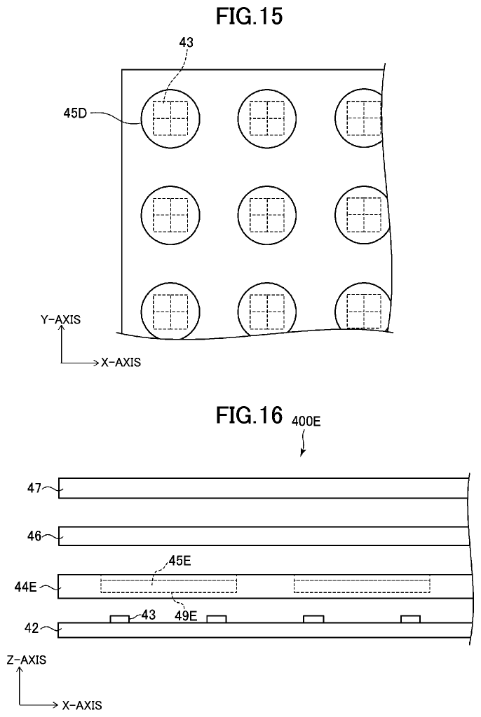

FIG. 15 is a transparent view of the plate 44D, the wavelength conversion sections 45D, and the light-emitting bodies 43 in accordance with the fifth embodiment as they are viewed from above. Referring to FIGS. 14 and 15, the wavelength conversion sections 45D are arranged next to each other in a lateral direction in the plate 44D. The “lateral direction” is perpendicular to the thickness direction of the plate 44D and matches either the X-axis or Y-axis direction shown in FIGS. 14 and 15. In addition, four (2×2) light-emitting bodies 43 are disposed next to each other in the fifth embodiment. Each wavelength conversion section 45D is provided collectively covering these four light-emitting bodies 43.

Each wavelength conversion section 45D needs only to at least partially overlap one or more of the light-emitting bodies 43 when viewed from above. In the fifth embodiment, each wavelength conversion section 45D overlaps all the four light-emitting bodies 43 when viewed from above as shown in FIGS. 14 and 15. In other words, the wavelength conversion section 45D is provided in the passage of the light emitted by the four light-emitting bodies 43. The wavelength conversion section 45D can hence efficiently convert the light emitted by the light-emitting bodies 43.

In the backlight device 400D in accordance with the fifth embodiment, each wavelength conversion section 45D at least partially overlaps one or more of the light-emitting bodies 43 when viewed from above. In other words, at least one light-emitting body 43 and a wavelength conversion section 45D positioned over the light-emitting body 43 are paired up producing white light emission that is free from irregular color mixing. The display device 100 including the backlight device 400D in accordance with the fifth embodiment thus causes no irregular color mixing in local dimming drive, thereby preventing image quality degradation.

In addition, since the four light-emitting bodies 43 are disposed next to each other and covered by the wavelength conversion section 45D, the backlight device 400D can emit more intense light.

The number of light-emitting bodies 43 disposed next to each other is not necessarily four and may be selected appropriately in accordance with, for example, the necessary amount of light.

### 6. Sixth Embodiment

A description is given next of a backlight device 400E in accordance with a sixth embodiment. The description will focus on distinctions between the backlight device 400E and the first embodiment and may not mention similarities between the backlight device 400E and the first embodiment.

FIG. 16 is a side view of the backlight device 400E in accordance with the sixth embodiment. The members of the sixth embodiment that are the same as those of the first embodiment are denoted by the same reference numerals in FIG. 16, and description thereof is omitted. The backlight device 400E includes a plate 44E and a plurality of wavelength conversion sections 45E. The plate 44E further has a plurality of dents 49F at prescribed intervals in the top face thereof. Each dent 49E contains therein a different one of the wavelength conversion sections 45E.

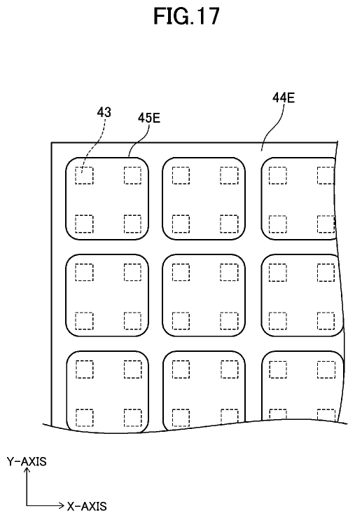

FIG. 17 is a transparent view of the plate 44E, the wavelength conversion sections 45E, and the light-emitting bodies 43 in accordance with the sixth embodiment as they are viewed from above. Referring to FIGS. 16 and 17, the wavelength conversion sections 45E are arranged next to each other in a lateral direction in the plate 44E. The “lateral direction” is perpendicular to the thickness direction of the plate 44E and matches either the X-axis or Y-axis direction shown in FIGS. 15 and 16. In addition, four (2×2) light-emitting bodies 43 are distanced from each other in the sixth embodiment. Each wavelength conversion section 45E is provided collectively covering these four light-emitting bodies 43. The wavelength conversion section 45E is a square with round corners when viewed from above, so that the shape of the wavelength conversion section 45E matches the layout of the four light-emitting bodies 43 covered by the wavelength conversion section 45E. The shape of the wavelength conversion section 45E is not necessarily limited to this example.

Each wavelength conversion section 45E needs only to at least partially overlap one or more of the light-emitting bodies 43 when viewed from above as described above. In the sixth embodiment, each wavelength conversion section 45E overlaps all the four light-emitting bodies 43 when viewed from above as shown in FIGS. 16 and 17. In other words, the wavelength conversion section 45E is provided in the passage of the light emitted by the four light-emitting bodies 43. The wavelength conversion section 45E can hence efficiently convert the light emitted by the light-emitting bodies 43.

In the backlight device 400F in accordance with the fifth embodiment, each wavelength conversion section 45E at least partially overlaps one or more of the light-emitting bodies 43 when viewed from above. In other words, one or more light-emitting bodies 43 and a wavelength conversion section 45E positioned over the light-emitting body/bodies 43 are paired up producing white light emission that is free from irregular color mixing. The display device 100 including the backlight device 400E in accordance with the sixth embodiment thus causes no irregular color mixing in local dimming drive, thereby preventing image quality degradation.

When the number and layout of the light-emitting bodies 43 do not change, the plate 44E in accordance with the sixth embodiment includes fewer wavelength conversion section 45E than the plate 44 in accordance with the first embodiment includes wavelength conversion sections 45. The plate 44E can be hence more easily manufactured.

The number of light-emitting bodies 43 covered by the wavelength conversion section 45E is not necessarily limited to four.

### 7. Variation Embodiments

The light-emitting bodies 43 are blue chip LEDs in the foregoing embodiments. Alternatively the light-emitting bodies 43 may be light-emitting elements other than LEDs.

The light-emitting bodies 43 emit Hue light in the foregoing embodiments. Additionally, the wavelength conversion sections 45 to 45E (hereinafter, collectively referred to as the wavelength conversion sections 45) contain a wavelength conversion material that converts blue light to green light and a wavelength conversion material that converts blue light to red light to produce yellow light. The light emitted by the light-emitting bodies 43 and the light emitted by the wavelength conversion sections 45 are not necessarily limited to these examples. Alternatively, as an example, the light-emitting bodies 43 may contain blue light-emitting elements and green light-emitting elements to produce cyan light. In such a case, the wavelength conversion sections 45 are made of a wavelength conversion material that converts blue and/or green light to red light. As another alternative, for example, the light-emitting bodies 43 may contain green light-emitting elements to produce green light. In such a case, the wavelength conversion sections 45 are made of a wavelength conversion material that converts green light to blue light and a wavelength conversion material that converts green light to red light. In such a case, the wavelength conversion sections 45 emit magenta light. There are various combinations available for the light emitted by the light-emitting bodies 43 and the wavelength conversion sections 45 as described here. In any of these cases, the wavelength conversion sections 45 convert the first light emitted by the light-emitting bodies 43 to the second light. As an additional note, research and studies are conducted on so-called “light upconversion” technology where light is converted from a relatively long wavelength to a relatively short wavelength, for example, from green to blue.

The wavelength conversion sections 45 contain quantum dots as a wavelength conversion material in the foregoing embodiments. Alternatively, the wavelength conversion sections 45 may contain a wavelength conversion material other than quantum dots.

The wavelength conversion sections 45 contain a wavelength conversion material that converts blue light to green light and a wavelength conversion material that converts blue light to red light in the foregoing embodiments. Alternatively, the wavelength conversion material may be such as to emit light over a relatively broad spectrum, for example, emit light with a spectrum centered at yellow wavelengths and spreading into red and green regions. A liquid crystal display device needs a backlight device capable of illuminating the liquid crystal panel with white light containing red, green, and blue components. Therefore, the backlight device include no wavelength conversion sections 45 that emit pure yellow light, but may include wavelength conversion sections 45 that emit light the spectrum of which includes red and green wavelengths. A similar discussion applies to other color combinations.

The plates 44 to 44E in the foregoing embodiments (hereinafter, collectively referred to as the plate 44) have the dents 49 to 49E (hereinafter, collectively referred to as the dents 49) formed in the top face thereof. Alternatively, the plate 44 may have the dents 49 formed in the bottom face thereof. In such a case, the wavelength conversion sections 45 are also provided in the bottom face of the plate 44. The bottom Ike of the wavelength conversion section 45 may reside above the bottom face of the plate 44.

The plate 44 is made of a transparent white polycarbonate resin in the foregoing embodiments. Alternatively, the plate 44 may not be white so long as it is transparent. The plate 44 may be, for example, colorless and transparent. In addition, the plate 44 is not necessarily made entirely of a transparent white material and may be, for example, partially made of a colorless transparent material. Additionally, the plate 44 may be made of any substance commonly used in the field that is chosen appropriately, other than polycarbonate resin.

The wavelength conversion sections 45 are circular when viewed from above in the foregoing embodiments. Alternatively, the wavelength conversion sections 45 may have any non-circular shape when viewed from above. The wavelength conversion sections 45 may have a shape that is, for example, modified in accordance with the light emission properties of the light-emitting bodies 43.

The plate 44 has the dents 49 formed therein, and the dents 49 contain the wavelength conversion sections 45 respectively, in the foregoing embodiments. Alternatively, the plate 44 may include the wavelength conversion sections 45 without being provided with the dents 49. The wavelength conversion sections 45 may be provided, for example, by preparing disc-shaped pellets encasing quantum dots in a resin in advance and placing the pellets in the prescribed location in the top or bottom face of a plate that has no dents.

The display panel 300 is a liquid crystal display panel in the foregoing embodiments. Alternatively, the display panel 300 may be, for example, a display panel with pixels formed of MEMSs (micro-electro-mechanical systems). The MEMS is an integrated device including mechanical elements, actuators, and electronic circuits on a single silicon or glass substrate. A panel including MEMS-based pixels includes thereon mechanical shutters serving as pixels. The mechanical shutters are opened and closed at high speed in accordance with an image signal. Similarly to the liquid crystal panel, the MEMS is thus capable of adjusting transmittance for the backlight emission to display an image. Alternatively, the display panel 300 may be a display panel including electrowetting-based pixels. Electrowetting is a phenomenon where turning on a switch provided between an electrode on an inner face of a thin tube and an external electrode changes the wettability of the liquid with respect to the inner face of the thin tube and reduces the contact angle of the liquid on the inner face of the thin tube, thereby causing the liquid to spread, and turning off the switch changes the wettability of the liquid with respect to the inner face of the thin tube and abruptly increases the contact angle, thereby causing the liquid to flow out of the thin tube. Similarly to the pixels in the liquid crystal panel, the electrowetting-based pixels can be opened/closed by turning on/off the switch and are thus capable of adjusting transmittance for the backlight emission to display an image. The backlight devices 400 and 400A to 400E of the foregoing embodiments may be applied to display devices that do not implement local dimming drive.

The present invention is not necessarily limited to the foregoing embodiments and examples. Embodiments based on a proper combination of technical means disclosed in different embodiments and those based on modifications of the foregoing embodiments are encompassed in the technical scope of the present invention.

### Software Implementation

The control unit 200 in the display device 100 may be implemented by logic circuits (hardware) fabricated, for example, in the form of an integrated circuit (IC chip) and may be implemented by software.

In the latter form of implementation, the display device 100 includes a computer that executes instructions from programs or software by which various functions are provided. This computer includes among others at least one processor (control device) and at least one storage medium containing the programs in a computer-readable format. The processor in the computer then retrieves and runs the programs contained in the storage medium, thereby achieving the object of an aspect of the present disclosure. The processor may be, for example, a CPU (central processing unit). The storage medium may be a “non-transitory, tangible medium” such as a ROM (read-only memory), a tape, a disc/disk, a card, a semiconductor memory, or programmable logic circuitry. The display device 100 may further include, for example, a RAM (random access memory) for loading the programs. The programs may be supplied to the computer via any transmission medium (e.g., over a communications network or by broadcasting waves) that can transmit the programs. The present disclosure, in an aspect thereof, encompasses data signals on a carrier wave that are generated during electronic transmission of the programs.

1. A backlight device comprising:
a plurality of light-emitting bodies arranged in a planar manner, the light-emitting bodies being configured to emit first light upwards; and
a transparent plate above the light-emitting bodies, wherein
the plate includes a plurality of wavelength conversion sections arranged next to each other in a lateral direction, the wavelength conversion sections being configured to convert the first light to second light, and
each of the wavelength conversion sections at least partially overlaps at least one of the light-emitting bodies when viewed from above.

2. The backlight device according to claim 1, wherein
each of the wavelength conversion sections is provided in a location overlapping one of the light-emitting bodies when viewed from above
the wavelength conversion sections are circular when viewed from above, and
the wavelength conversion sections each have a diameter larger than dimensions of a light-exiting portion of the light-emitting bodies.

3. The backlight device according to claim 1, wherein
the plate has dents in either one or both of top and bottom faces thereof, and
the wavelength conversion sections reside in the dents.

4. The backlight device according to claim 3, wherein the dents reside in the top face of the plate.

5. The backlight device according to claim 4, wherein the wavelength conversion sections each have a top face below the top face of the plate.

6. The backlight device according to claim 3, wherein the dents reside in the bottom face of the plate.

7. The backlight device according to claim 6, wherein the wavelength conversion sections each have a bottom face above the bottom face of the plate.

8. The backlight device according to claim 1, wherein the plate contains a white material.

9. The backlight device according to claim 1, further comprising a frame member on a bottom face of the plate, the frame member being configured to divide the plate into a plurality of regions.

10. The backlight device according to claim 1, wherein the plate comprises a plurality of the plates arranged in a planar manner.

11. The backlight device according to claim 10, wherein those plates that are adjacent to each other are separated by a distance.

12. The backlight device according to claim 1, wherein the plate has a plurality of projections on either one or both of top and bottom faces thereof.

13. The backlight device according to claim 1, wherein
the first light emitted by the light-emitting bodies is blue light, and
the wavelength conversion sections convert the blue light to green and red light to output yellow light as the second light.

14. The backlight device according to claim 1, wherein the wavelength conversion sections contain quantum dots.

15. The backlight device according to claim 1, the light-emitting bodies are separated by a distance from the plate.

16. A display device comprising:
the backlight device according to claim 1;
a display panel configured to display an image by using light exiting the backlight device; and
a control unit configured to receive an input of image data sets each specific to one of areas into which a display region of the display panel is divided and to implement local dimming drive where the backlight device and the display panel are controlled based on the image data sets so as to display an image represented by the image data sets.
